(19) United States
(12) Patent Application Publication
(10) Pub. No.: US 2015/0084472 A1
(43) Pub. Date: Mar. 26, 2015

(54) Electrical Power Motor-Generator Excited by Magnetic Transference

(71) Applicants: Arturo Perez Rodriguez, Madrid (ES); Jose Luis Lopez Martin, Madrid (ES)

(72) Inventors: Arturo Perez Rodriguez, Madrid (ES); Jose Luis Lopez Martin, Madrid (ES)

(21) Appl. No.: 14/388,345

(22) PCT Filed: Mar. 21, 2013
(86) PCT No.: PCT/ES2013/070184

§ 371 Date: Sep. 26, 2014

(30) Foreign Application Priority Data
Mar. 28, 2012 (ES) P201200334

(51) Int. Cl. H02K 21/38; H02K 21/04

(52) U.S. Cl. CPC H02K 21/38; H02K 21/04
USPC 310/181

(57) ABSTRACT

The invention relates to an electrical power motor-generator excited by magnetic transference, and which further comprises a stator (1) and a rotor (2) with an external core (3) stationary relative to the stator and rotor, said external core (3) comprising: an outer axial part, or axial armature (6) joined to the stator (1), an inner part that communicates through an air gap (4) with the rotor (2), a third part, disk (8), that joins the other two parts, where the rotor does not have any excitation coils, and hence no rings or collector brushes. The outer core (3) has an axial permanent magnet (12) and permanent magnets (10) on the outer axial part (6) thereof, and electromagnets (11) in the other two parts or on the disk (8). The rotor does not have brushes to create a magnetic field, which is created by the magnets and coils of the outer core (3), the magnetic flow transmitting the induction flow to the rotating rotor, through an air gap, thus dispensing with rings and collector brushes.

The machine that is claimed pertains to the technical field of electromagnetic generators and motors. It is a device to transform mechanical power, i.e. a moving force, into electrical energy, and vice-versa. It is an electrical machine in which the magnetic flow enters the rotor by transference through a passive air gap from a source of static magnetic flow.

### STATE OF THE ART

There are automotive alternators in which electromagnetic excitation is static, but whose magnetic flow passes through four air gaps and the shape of the magnetic circuit thereof in the stator is of the conventional type, all of which make them completely different from the one that is claimed.

The utility model U 200402396 owned by one of the applicants of this invention patent, has static electromagnetic excitation, with a single central axial coil and only two air gaps per pole, as claimed in this invention patent.

However, the proposal in this patent includes excitation by means of only one central permanent axial magnet 12 and by several 10, on the disk or on the axial armature, alone or combined with multiple excitation coils 11 with their cores incorporated between the central part of the disk 8 and the outer ring-shaped crown of the disk 8 or between the two rings of the axial armature 6; the shape and distribution of the rotor and stator poles is specific to this patent; there is multiple flow variation, triple in the embodiment presented; all of which makes it substantially different from the aforementioned utility model in the structure thereof and the effects produced.

It is also different from the aforementioned utility model because, with the addition of the squirrel cage 18 on the rotor 2, the new basic synchronous alternator is transformed into an asynchronous motor-alternator, one of those identified as being preferred for driving electric and hybrid vehicles, and for wind turbines, without the problems that this addition causes in conventional synchronous alternators.

### SUMMARY OF THE INNOVATION

The technical problems of the conventional machines and the reasoned solutions that the proposed invention brings are presented below.

a). In all generators, and especially those aimed at automotives and wind generation, obtaining power at low speeds without increasing the size of the machine is a problem, since at high speeds the voltage is more than sufficient and therefore must be limited by the chosen regulation system.

FIG. 3 shows how the flow variation per turn in the case of the innovation is 3×F, triple that of conventional cases, on the coil considered, R, of a three-phase stator. This may only be carried out in the machine currently claimed because the flow is unidirectional.

FIG. 4, of a conventional alternator, shows that the rotor pole 33 produces successive flow variation F on only one of the three the stator poles encompassed by the phase “R” coil, while in the innovated alternator, FIG. 3, variation is produced at the same time on the three poles comprised by the phase “R”, which should have equal flow per pole, i.e. 3×F.

The voltage calculations, applying the relevant electro-technical formulas show this assertion.

The basic formula:

Voltage=Flow variation/Time taken for variation to take place

Applied correctly, the formula proves it and the experiment confirms it.

b). Cooling at low speeds is also a problem for conventional alternators, because it limits the power that may be obtained. The cross-section of the electrical conductor of the stator winding determines the number of turns per coil and this determines the coil voltage. The greater the voltage per turn obtained, the less ohmic loss there is because fewer turns per coil are needed for the same coil voltage.

It is clear that the innovation reduces the unwanted heat produced as the voltage is considerably increased and the length of the coil wire is reduced, and thus the ohmic resistance thereof.

c). Another problem that conventional automotive alternators have is the amount of copper that the excitation coils require, and the heat these generate.

It may be seen in FIG. 1, which shows the schematic arrangement of an alternator according to the innovation proposed, that excitation coils 11 with their cores, i.e. electromagnets, completely replace a circular crown of the disk 8 of the outer core with ventilation windows 20 between each one of them. Moreover, they are coils with very few layers because it is the total of a conventional automotive alternator divided by the number of electromagnets and they have a large surface in contact with the outer core and the air, as a result of which cooling is direct and efficient. The coil 13 wrapped over the central magnet 12. All or part of the electromagnets may be substituted by permanent magnets 10, with the North poles thereof facing the same direction, towards the periphery of the disk, FIG. 2, position 30, or vice-versa, as a result of which the flows thereof join together giving rise to the total flow.

The calculations show that for the same number of ampere-turns and equal copper wire diameter, this arrangement requires a fraction of the copper wire length of a conventional one and has a much larger outer cooling surface and much less ohmic resistance than a conventional one because a central coil on a large-diameter core is substituted for several on small cores. The amount of heat generated by the excitation current is less due to the lower ohmic resistance. Moreover, and very importantly, the amount of copper used in excitation, in the case of electromagnets, is much less than in conventional ones. In the multiple coil version, it is one third. Therefore, they generate much less heat. The calculations show that for the same induction in the active air gap, the amount of copper is approximately a third and the heat dissipated is half or less. In addition, the cost is lower, despite there being several coils, because they are smaller and have much less copper.

The excitation coil cooling is much better because they generate less heat and because they are joined to a significant mass of iron, situated on the outside of the machine and the exposure thereof to the cooling medium, generally air, is much greater and more efficient due to having a greater surface than a single, large-diameter central coil. A simple calculation shows that the surface of automotive alternators equally exposed to induction in the active air gap is much greater with multiple coils than with one central coil.

The air cooling fan 28 does not necessarily need to be mounted only on the rotor. There may be another 21, with a larger diameter and more efficient, mounted on the outside of the magnetic keeper, but inside the armature 27 of the machine.

This enables the heat created when electrical power is generated to be slowly expelled outside. This is very important.

Likewise, the number of ampere-turns may be increased because there is space for it, without affecting the size of the rotor and stator due to scale. This is also very important.

d). In conventional and automotive alternators, FIG. 4, the excitation coil or coils 35, are on the rotor, which rotates, thus meaning that rings and brushes 36 are needed to supply them with the electric excitation current.

In the innovation there are no rings nor the brushes thereof because the excitation coils are static. This, too, reduces cost.

e). The use of permanent magnets instead of excitation coils is highly valued, because it does not use copper in the excitation, but it has the drawback that the permanent magnets in the known generators are placed on the rotor. Voltage regulation must be done through the stator by complicated and expensive means because the permanent magnets give a certain, fixed induction and rotate with the rotor.

f). Wind turbines with conventional permanent magnets have a certain start-up torque called “cogging”, which prevents them from starting up at certain wind speeds, even though it is sufficient to generate energy once started-up.

The innovation that is proposed resolves these two problems, e) and f), since the excitation magnet or magnets 10 are not on the rotor; they are static since they are on the outer core and the magnetic field acting upon them may be adjusted via a coil of electricity-conducting filament 13 wrapped around them or via the combination of permanent magnets and electromagnets to regulate and eliminate cogging. This is achieved in the following way: see FIG. 2.

The magnetic polarity of the permanent magnets 10 and the electromagnets 11 faces in the same direction, for example, towards the periphery of the disk 8. See FIG. 2, position 30. Therefore, the flow between them is added and goes through the external core 3 to the stator and returns through the air gaps 5 and 4 to the central part of the external core, formed by a permanent magnet 12 with the coil 13 thereof, to the disk 3 and from the latter to the electromagnets 11 with soft iron cores and permanent magnet 10 cores, thus completing the magnetic circuit. However, if the supply of the soft iron core electromagnets 11 is removed, the flow of the magnets circulates through the circular crown of the disk 8 and returns through the same to the opposite pole of the magnet, and therefore, the excitation and cogging disappear. See the closed circuit 31 in FIG. 2.

If there were only permanent magnets, 10 and 12, as the windings 13 that are on them are excited with an inverse current, they subtract their own flow from that of the magnets until they are cancelled out. The windings 13 are also used to restore the magnetism of the magnets in the event that they have lose it.

The use of electromagnets combined with permanent magnets, with or without coils on the latter, to produce excitation, which is claimed in this patent, may also be applied to generators in which excitation is installed in the rotor, FIG. 4, for which reason it is likewise proposed as an independent claim.

In both cases, the form described above enables very simple and low-cost regulation to be carried out, as well as removing the cogging or start-up torque due to the presence of the permanent magnets. This is very important for wind turbines, especially those with power between 3 and 8 kW.

g). Conventional synchronous alternators cannot be converted into asynchronous motors because they have the problem that during start-up and, to a lesser extent, normal operation, the rotation field of the stator induces dangerous currents in the windings of the inductor, because the magnetic circuit closes through the poles of the rotor where the inductor coils are located. See FIG. 4.

Generators with excitation by magnetic transference technology, have a secondary or passive air gap 4, as stated in the description, FIG. 1, in which there is only flow transmission, without variation of the same. This means that there are no induced currents, and an active air gap 5, in which variation to flow, as well as the induced voltage and current, is produced when operating as a synchronous generator.

When operating as a hypo-asynchronous motor or hyper-asynchronous generator, only the existing dispersion flow and the regulation flow pass through the secondary air gap 4. It has been demonstrated experimentally this it is very small.

This essentially differentiates the machine claimed as a synchronous generator and asynchronous machine, with conventional synchronous alternators with squirrel cage or coil rotor start-up, in which the two air gaps are active. This difference is very important, as explained below:

The rotation field produced by the stator, supplied by the appropriate polyphase voltage and current system, produces high induced voltage in the excitation coils in conventional synchronous alternators, because they are in the rotor and are crossed by it. See FIG. 4. They are dangerous and are avoided using known and expensive devices. In the arrangement of the innovation for excitation by magnetic transference, the induced currents are closed on the core of the rotor, without significantly affecting the excitation winding that is not on the rotor but on the external core. See FIG. 3, circuit 32.

h). In the case of generators with conventional permanent magnets placed in the rotor, the conversion to an asynchronous motor is not possible because it demagnetises the magnets.

The innovation proposed does not have this problem because the magnets are not in the rotor but rather in the external core where the flow induced by the stator coils does not reach, which coils close over the keeper of the rotor as in a conventional asynchronous machine. See FIG. 3, circuit 32.

### DRAWINGS

FIG. 1.—Cross-section of the innovated alternator, with coils and permanent magnets in the disk, in the axial armature and the central core.

FIG. 2.—Arrangement of magnets and electromagnets and regulation and anti-cogging coils on the disk.

FIG. 3.—Flows in the innovated alternator.

FIG. 4.—Flows in the conventional alternator.

### DESCRIPTION OF AN EMBODIMENT

Below is a description of an embodiment and of the various possibilities with the technology contained in the explanation and in the claims, without this entailing any restriction on the scope of the patent.

All the components that form part of the innovation have been included, for a better understanding thereof, even if their number and presence are not the same as those in other embodiments.

The machine has an aluminium front shield 22 that houses the rolling front bearing 23, for the shaft 24 of the machine, which rotates at its other end on another bearing 25 whose support 26 is held in the disk of the external magnetic core 3 to guarantee the air gaps 4 and 5. An aluminium outer cover 27 closes the protective armature, which contains the main fan 21. There are another two internal fans, 28.

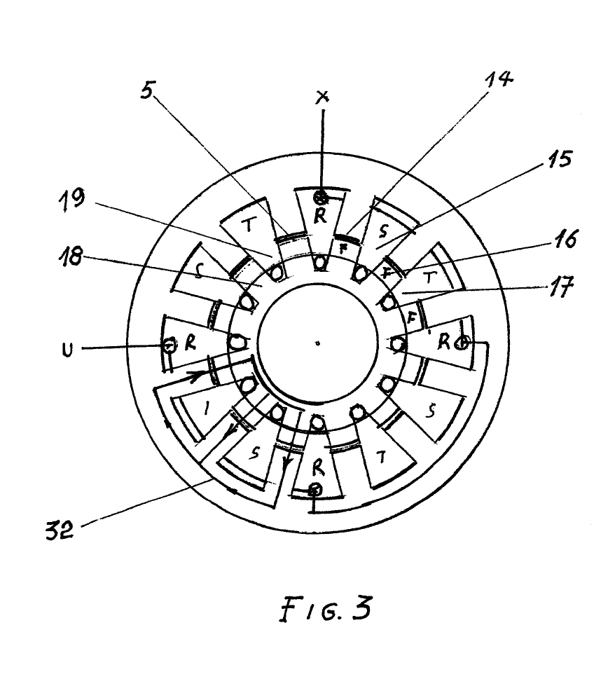

FIG. 3 shows the cross-section of an innovated synchronous generator provided with a squirrel cage 18, with the ventilation channel 19 thereof to convert it into an asynchronous machine.

The stator 1 is joined by mechanical contact to the external core 3, which in turn is facing the rotor 2 through the secondary or passive air gap 4.

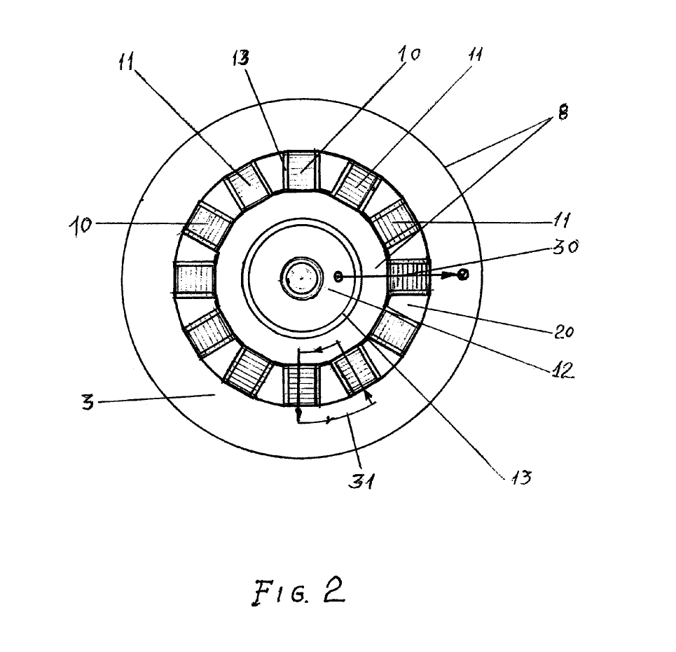

The inducing coils 11 and the permanent magnets 10 are inserted in the magnetic circuit 29, with the polarities thereof facing in the same direction as the field, 30, FIG. 2. The central permanent magnet 12 is crossed by the total flow transmitted through the passive air gap to the rotor 2.

The poles 16 of the rotor 2 face the poles 14 of the stator, through the active air gap 5. See FIG. 3.

In FIG. 2, electromagnets 11 and the permanent excitation magnets 10 situated on the disk 9 are represented, not those mounted on the outer axial part 6. The operation is the same.

The electromagnet 12 is situated in the central area surrounded by a coil 13, in the same way as the other permanent magnets 10 situated in the disk 8.

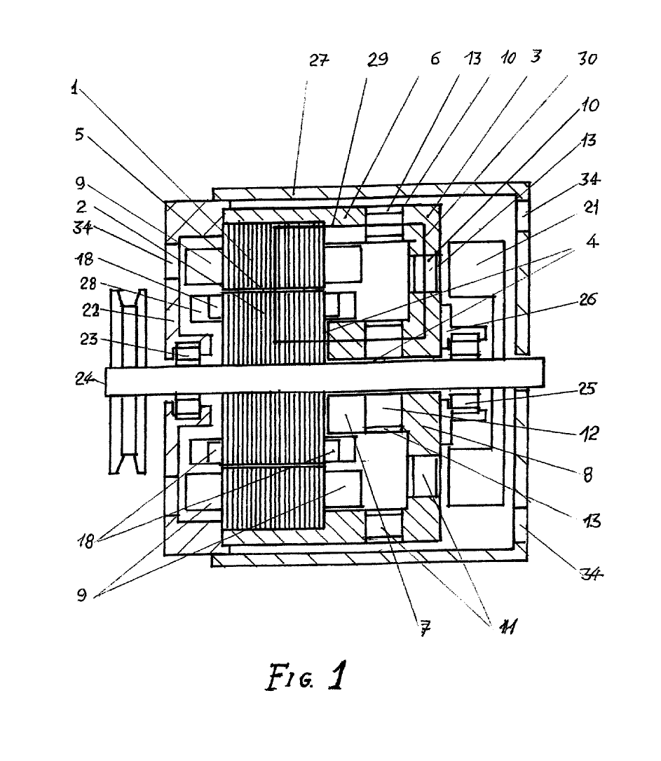

The magnetic flow path in FIG. 1, with a closed line 29, which, starting from the electromagnets or the permanent magnets, continues through the disk 8, goes over the axial core 6, axially and radially crosses the stator keeper 1, passes from the latter to the rotor 2 poles, through the active air gap 5; from the rotor 2 it passes through the passive air gap 4 to the central permanent magnet 12; from here, by mechanical contact, to the disk 9 and returns to the electromagnets or permanent magnets 10 and 11.

There are several ways to operate as a synchronous generator:
a) With excitation by means of electromagnets. Advantages: less Cu content, less ohmic heat in the rotor and stator, conventional voltage regulation.
b) With excitation just by means of permanent magnets. Advantages: very low manufacturing cost. The claimed regulation and preservation of the magnetism: each permanent magnet has a coil 13 wrapped around it, via the supply of which, with the appropriate current, the magnet flow may be cancelled out and the value thereof adjusted, or the magnetism thereof may be restored.
c) With mixed excitation, by means of electromagnets and permanent magnets. Advantages: less copper content and less heat in excitation that a). No cogging, the permanent magnets do not demagnetise, easy and cheap regulation from the excitation.
d) With excitation by means of only the central permanent magnet. Very low-cost solution, typical of low-power wind turbines.

All of them have the advantage of being able to transform into an asynchronous machine by adding a squirrel cage 18 on the rotor.

The appropriately supplied electromagnets are equivalent to a permanent magnet, both with equal polarity facing, for example, towards the periphery of the disk 8, see FIG. 2, position 30; they create the total magnetic field, and the induction B in the active air gap 5, where the flow variation is produced that generates the voltage in the stator windings.

As the excitation is removed from the electromagnets, the flow of the permanent magnets closes on itself, cogging is eliminated and the voltage is easily regulated and at a low cost. This play of magnetic fields is represented in FIG. 2, in the disk 8, position 31.

This requires the number of electromagnets and permanent magnets to be the same.

The cost of several excitation coils with the cores thereof is lower than that of the single central coil used by automotive alternators because it has much less copper as the diameter of the core is much smaller. A simple calculation demonstrates this.

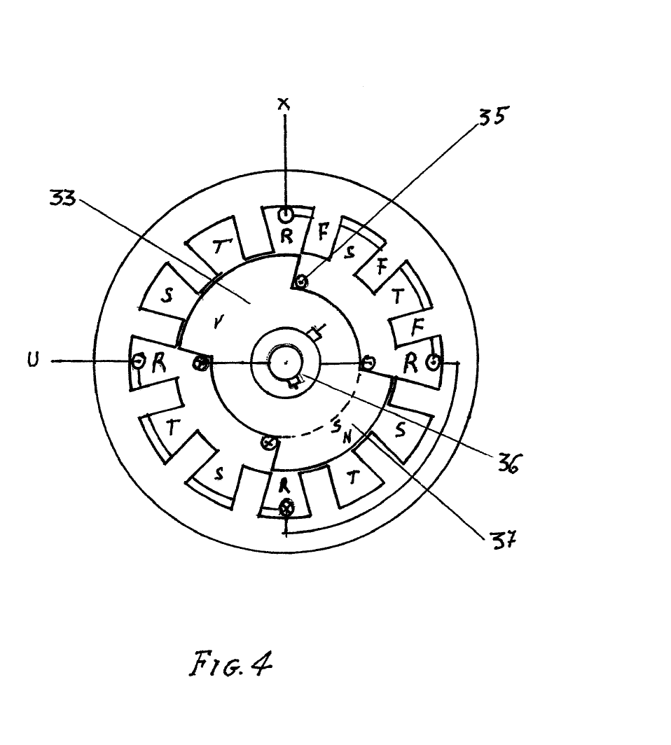

With regard to the poles or projections of the keepers of appropriate magnetic material, for example a thin magnetic sheet to reduce losses due to hysteresis, FIGS. 3 and 4 show the difference between a conventional alternator and the innovated alternator.

In the innovated alternator, FIG. 3, the width of the stator poles 14 and the rotor 16 are equal, measured in the air gap while the corresponding grooves, 15 of the stator and 17 of the rotor, may be equal to the width of the poles or by up to 25 percent greater to modify the shape of the voltage waveform. In FIG. 3 they are equal.

Each stator pole faces one rotor pole, and as each turn of the coil comprises three stator poles, the flow variation, for equal speed and flow, is triple, the voltage thereby being triple.

In the conventional alternator, FIG. 4, each rotor pole 33, faces three stator poles, precisely those encompassed by the average polar pitch. As the rotor rotates, the pole thereof 33 varies the flow on a single stator pole until the next groove, thus meaning that the flow variation is one third of that of the innovated alternator.

FIG. 3 shows the closure of the force lines when the innovated machine operates as an asynchronous, circuit 32. The force lines of the rotating magnetic field created in the stator by a polyphase current, for example three-phase, is closed in the core of the rotor because the length of the magnetic circuit is smaller and has less reluctance than the circuit in FIG. 2, position 30 (partial) and 29 in FIG. 1.

The rotor of a conventional synchronous machine with permanent magnets, FIG. 4, has the excitation magnet or magnets 37 on the poles thereof. In the innovation proposed, the permanent magnets have a coil wrapped around each one of them, via which the resulting magnetic field may be varied, to regulate the voltage, avoid cogging and restore magnetism if it has been lost.

The same effect is achieved by combining permanent magnets and electromagnets in a manner similar to that explained above for the excitation mounted on the disk 8 of FIG. 2, position 31.

Position 34, FIG. 1 are ventilation windows of the aluminium armature.

1. An electrical power motor-generator excited by magnetic transference, of the variety in which the keepers made of magnetic conductor material of the stator and rotor, the latter rotating inside the former, are communicated by an external core of magnetic conductor material, which differs from both and is stationary relative to them, this core being joined to the keeper of the stator by direct contact, and to that of the rotor by a secondary air gap, which, in turn, faces the stator through an active air gap; the core having an outer axial part, which is joined directly to the keeper of the stator, referred to as the axial armature, an inner part, referred to as the central core, which communicates with the keeper of the rotor through the secondary air gap and a third part, which is located between the two aforementioned parts and joins them together, which is referred to as the disk; all of these parts being made of magnetic conductor material, with little or no magnetic remanence, such as soft iron and thin sheets of magnetic steel;
the rotor having no excitation coil, as far as operating as a synchronous generator is concerned, thus meaning it does not have collector rings or brushes;
the keeper of the stator supports a conventional polyphase winding or individual coils on each projection;
the electrical power motor-generator being excited by magnetic transference; the external core having a complete ring-shaped cross-section of the axial armature and a complete circular crown of the disk, replaced or formed by permanent magnets and electromagnets, and ventilation windows, between every two of them and a section of the central core replaced or formed by an axial permanent magnet.

2. The electrical power motor-generator excited by magnetic transference according to claim 1, wherein the permanent magnets and the axial permanent magnet are each surrounded by an electricity-conducting filament winding, of which they are the corresponding magnetic core, both forming electromagnets with a permanent magnet core.

3. The electrical power motor-generator excited by magnetic transference according to claim 1, wherein the projections and grooves of the stator and the projections and grooves of the rotor have the same angular width, measured in the active air gap, which should be zero, and take up the entire surface of the active air gap, upon which they are distributed at equal distances from one another.

4. The electrical power motor-generator excited by magnetic transference according to claim 1, wherein the projections of the stator and of the rotor have the same angular width, measured in the air gap, which should be zero, a width that is narrower than usual and equal to the grooves, by up to 25 percent, and take up the entire surface of the active air gap upon which they are distributed at equal distances from one another.

5. The electrical power motor-generator excited by magnetic transference according to claim 1, wherein the rotor is provided with a winding in the form of a squirrel cage, which has the same form as that of conventional asynchronous motors.

6. The electrical power motor-generator excited by magnetic transference according to claim 1, wherein the squirrel cage leaves a free space or ventilation duct in each groove of the rotor, which crosses the keeper from one side to the other.

7. An electrical power motor-generator, wherein the excitation is situated in the rotor, wherein the excitation is formed by electromagnets and by permanent magnets, it being possible for the latter to be surrounded by an electricity-conducting winding.
